(19) United States
(12) Patent Application Publication
(10) Pub. No.: US 2004/0105957 A1
(43) Pub. Date: Jun. 3, 2004

(54) Security features

(76) Inventor: Frank Puttkammer, Coswig (DE)

Correspondence Address: Law Offices of Karl Hormann, PO Box 381516, Cambridge, MA, 02238, US

(21) Appl. No.: 10/469,794

(22) PCT Filed: Feb. 28, 2002
(86) PCT No.: PCT/DE02/00748

(30) Foreign Application Priority Data
Mar. 1, 2001 (DE) 101 11 847.3

(51) Int. Cl. B32B 3/10

(52) U.S. Cl. 428/137

(57) ABSTRACT

The invention relates to security features, preferably connectors, for instance tax seals, labels, closures of blister packages and integral markings for connecting seams of products or product packages for identifying the genuineness of products. The security features in accordance with the invention are made up of several different components, encoding means and electrically conductive layers connected to a support substrate in various arrangements. Layers of electrically conductive polymers known per se are being used. The security features constitute insurmountable obstacles for forgers.

The invention relates to security features, preferably connectors, for instance tax seals, labels, closures for blister packages and sheet markings for connecting seams on products or packages of products, for identifying the genuineness of products.

In consequence of product piracy and the unauthorized production of various brand products, e.g. in the pharmaceutical, textile and cosmetics industries as well as in the field of spare parts, producers of original equipment suffer enormous commercial damage and losses of reputation. In product piracy and the unauthorized production of high-priced consumer goods which do not correspond to the quality of genuine articles, both producer and a large section of consumers are interested in being able to test the authenticity of goods. For this purpose, it is customary to apply visible security elements to them. Holograms, for instance, are applied to products. A further possibility resides in applying security elements to packages of goods. For instance, for opening packages, threads, tapes or twines are inserted over seams surrounding the packing material. As a security characteristic, the color of the so-called closure and tear-open means usually differs from the packaging and in some cases they are provided with a sharp perceptible edge. One end of the tear threads is usually structured as a freely protruding which may be conveniently grasped by a user. Even the structure of the tongue, for instance its shape, length or width, is being used as a proof of quality.

Even though in products of lower value such efforts are dispensed with and often the tear strip is made of the same material as the packing material, it is increasingly recognized that hitherto used characteristics of identifying genuineness are insufficient effectively to protect the original. On the basis of the progressive development of technology accessible to forgers genuineness and security features can be easily copied and produced. The demand for raising the technological obstacle for forgers is growing steadily.

In many fields of the economy producers suffer significant losses as a result of so-called “gray goods”. With respect to such “gray goods” consumers are not usually interested in testing their genuineness. The goods correspond to the original ones and usually they are available at a much lower price. It is here where producers have the highest interest in testing authenticity. It is here where concealed security features invisible to human vision are preferredly applied. The consumers are not being confused by changed designs. Not knowing the kind and position of the security features is to prevent a forger from adapting to the testing technology and testing devices when producing the package, for instance, of “gray goods”.

A common problem in product piracy as well as in the unauthorized manufacture is the unauthorized manufacture or theft of packaging and outer wraps for packing forgeries or gray goods and for misrepresenting their originality.

WO 99/43556 A1 describes several security features for packages with one ore more perforated holes which may represent company logos, for instance. Furthermore, tear strips are being used with individual metalized sections which have de-metalized zones represent figures and letters within the metalized sections and/or which represent holograms. Also, a combination of an optically effective security feature with an electrically active characteristic dye for the encoding of information is being described.

DE 198 08 288 A1 proposes to metalize individual sections of the tear strip, preferably at a coating thickness of from 70 nm to 200 nm, and within those sections to demetalize zones, representing figures or letters, for instance. It is not compatible with manufacturing methods and manufacturing rates hitherto employed. Structuring with masks or other covers does neither yields a sufficiently high resolution nor a long usable life.

Furthermore, metalizing coatings are known which are produced by printing. Depending on the type of printing as, for instance, diffusion printing, coatings manufactured by metallic printing dyes, yield a higher resolution. The selection of primer makes possible to set partial surface resistances. The brilliancy of the surface is below that of coatings produced by vacuum coating processes. No flawless industrially usable technologies, and, more particularly, vacuum technologies, are available for security features realized by metalizations with partial changes in surface resistances while at the same time providing the highest possible brilliancy because the usual processing and production rates of ≧500 m/min cannot be achieved.

Forgers not only master on a large scale all security features, precautions and techniques, but often they apply them on an industrial scale so that forgeries and “gray goods” are being increasingly offered in all markets.

It is an object of the invention, in addition to overcoming the disadvantages of the prior art, to provide connectors—of the kind to be defined hereinafter—for identifying the genuineness of products. Technological obstacles insurmountable for forgers are to be proposed from the selective combination of metalized surfaces, surface brilliancy, electrical conductive surfaces and changes in surface resistances which is known only to its manufacturer or authorized control agents.

Before describing the invention, terms as understood herein and throughout the patent claims will be defined. Hereafter, connectors will, for instance, be collectively understood to include the most variegated sheet markings for connecting seams on products or product packages, labeling, tax seals and closures for blister packages and the like. Surface metalization will be understood to be a homogeneously metalized surface with a homogenous surface brilliancy. Scattered metalization will be understood to be a non-homogeneously metalized surface, or a homogeneously metalized surface having demetalizations, or a homogeneously metalized surface with a non-homogenous surface brilliancy, or a homogeneously metalized surface with non-homogenous surface brilliancy and demetalizations. Substrate or support substrate defines any kind of material on or in which coding means for securing and/or coding may be attached or incorporated, material connoting. For instance, plastic or metal foil, paper, cardboard and textile webs. Coding means will in this specification and in the patent claims be understood to be means for securing and coding with electrical, optical or magnetic functionalities.

The security features in accordance with the invention are constructed of several different components, coding means and electrically conductive layers and are connected in various arrangements on a support substrate. Layers of electrically conductive polymers known per se are used. In accordance with the invention these security features constitute connectors defined supra in greater detail.

A precondition for using electrically conductive polymers in combination with a metalization layer is a noticeable difference between their surface resistances (=100 k=Ω/□). A very high surface resistance is required of the metalization layer (=200 k=Ω/□). Conventional and used technologies for metalizing result in low surface resistances. In particular, the coating with an electrically conductive polymer, e.g. polyethylene dioxythiophene polystyrene sulfonate, in combination with a metalization layer, is to be used as a technical obstacle against forgers, the PEDT/PSS being characterized by a surface resistance in the range of 15-100 k=Ω/□. With the use of a primer, a surface resistance of 50 k=Ω/□ will be attained on PE foils.

The polymer layer is applied as an integral surface or partially and is preferably applied in a surface-modulating manner or by scattered printing. A readable code is obtained as a result of the partially changing surface resistances. The code may be easily detected in different ways, especially by capacitive coupling. Automatic physical dual testing of the electrically conductive polymer PEDT/PSS detecting electrical conductivity on the one hand and optical properties, for instance in the IR range, is advantageous. The IR properties may be effectively used as a function of increasing wavelength (>900 nm) as well as weight of application or layer thickness. Absorption and changes in wavelength constitute measurable parameters. The dual test results in a significantly reduced probability of identifying counterfeits or the error rate of non-recognized forgeries or the error rate of genuine products detected as counterfeits.

A metalized surface to be used in accordance with the invention—especially of high brilliancy, of which it would have to be assumed that it possesses good electrical conductivity which might include an electrically conductive security element, or which by way of encoded changes in surface resistance would itself constitute a security element—constitutes a further obstacle against any forger since the task, function and functionality of the metalized surface is neither to be assumed nor obvious.

In particular, the invention relates to security features, preferably connectors, for instance tax seals, labels, closures for blister packages and sheet markings for connecting seams on products or product packages for identifying the genuineness of products. The connectors consist of substrates, integral or scattered metalized applications of a defined surface resistance and of electrically conductive polymers, also of a predetermined surface resistance. In accordance with the invention, the surface resistance of the integral or scattered metalized applications is greater than 200 kΩ/□ and the surface resistance of electrically conductive polymers ranges between 15 to 100 kΩ/□. The difference between the surface resistances of the applications and of the electrically conductive polymers is in excess of 100 kΩ/□.

The construction of the connector—i.e. the arrangement of substrates, electrically conductive polymers, integral or scattered applications, protective layers, release agents and/or adhesive layers—is selected according to intended uses. The individual layers are interchangeable. The used release agents preferably are siliconized layers or transfer ribbons or layers.

Depending upon intended application and used manufacturing technology, primers are used as bonding agents as well as, in accordance with the invention, for smoothing coated substrates. The electrically conductive polymers, the integral or scattered applications, the substrates, the optional protective layers and the primers are arranged as coding means such that their electrical or optical or magnetic functionalities may be detected by capacitive coupling, i.e. they are used as coding means.

In accordance with the invention the electrically conductive polymers may be applied sectionally or in a surface-modulating manner or as modulated surface sections. In this case, too, the resulting code may be detected by capacitive coupling. Similar sectionally or surface-modulating or sectionally surface-modulating applications may also be detected by capacitive coupling.

In accordance with the invention, the coding means of the security features may be affected physically or chemically. In particular, by applying energy, such as visible light, UV, IR or heat radiation, the coding means react, in a manner perceptible to an examining person, as indication of genuineness or originality either in the tear strips or in conjunction with the package. It is within the ambit of the invention, to use reaction dyes as coding means, individual components of the reaction dyes reacting with each other by contacting, thus serving as an indication of genuineness and originality. Preferably, the polymer used in accordance with the invention is polyethylene dioxythiophene polystyrene sulfonate (PEDT/PSS).

A special embodiment of the invention provides for joining partial connectors into a single connector. The individual partial connectors may, in the manner already described, consist of substrates, integral or scattered metalized applications and of electrically conductive polymers. The individual partial connectors may also consist of protective layers, release agent layers, bonding layers and a primer. The selection and arrangement of the individual layers depends upon the desired use and upon the processing technology. Different surface resistances of individual layers in the partial connectors here, too, are within the ambit of the invention. The partial connectors, made identically or of different structure, by themselves as well as after their connection to a complete connector result in codes and thus serve by the code to identify products, product components or product packages. Where codes are formed only after the partial connectors have been joined together, their exact interfit is an essential prerequisite. All coding means on the partial connectors and on the complete connectors may be aligned in different ways on the surface to which they are to be applied.

The invention will hereafter be described and explained with reference to the embodiments depicted in the drawings. In the drawings:

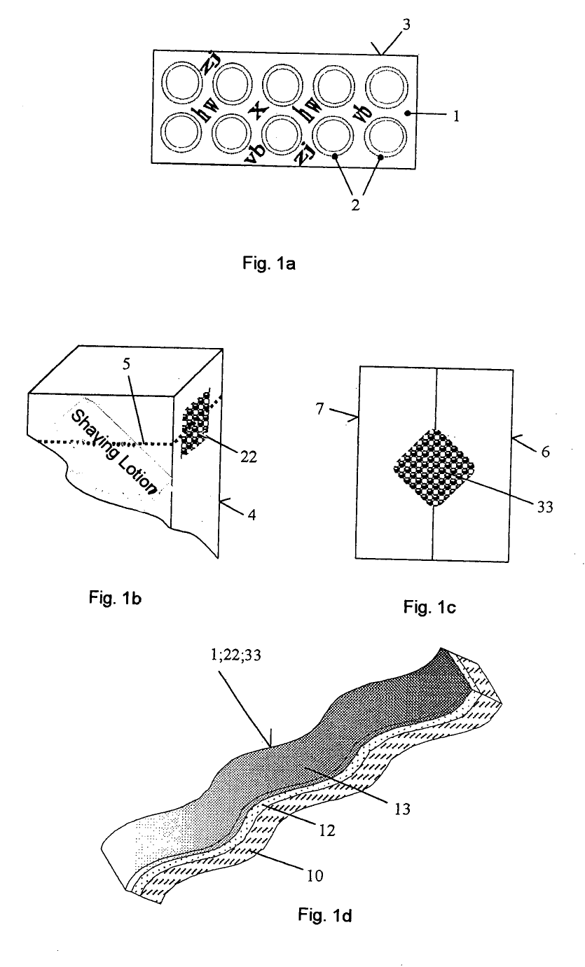

FIG. 1a is a schematic top elevational view of a blister-package for pills, with a closure;

FIG. 1b is a schematic partial view of a tax seal on a product;

FIG. 1c is a schematic partial view of a connection between to product components by means of a label;

FIG. 1d is a schematic partial rendition of a closure band of a blister-package for pills;

FIG. 1e is a schematic partial presentation of a tax seal with a code;

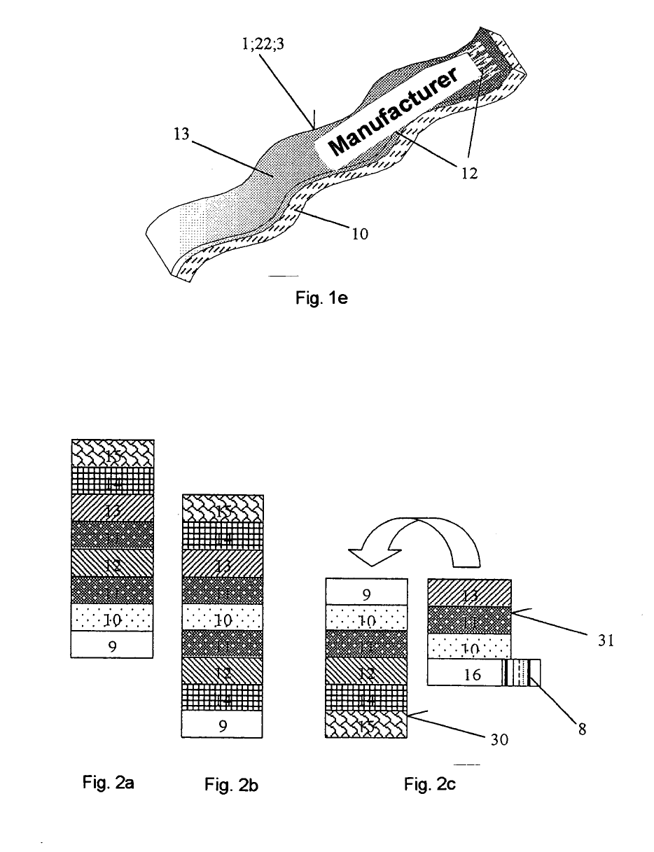

FIGS. 2a-2c depict the schematic layer structure of different variants of connectors;

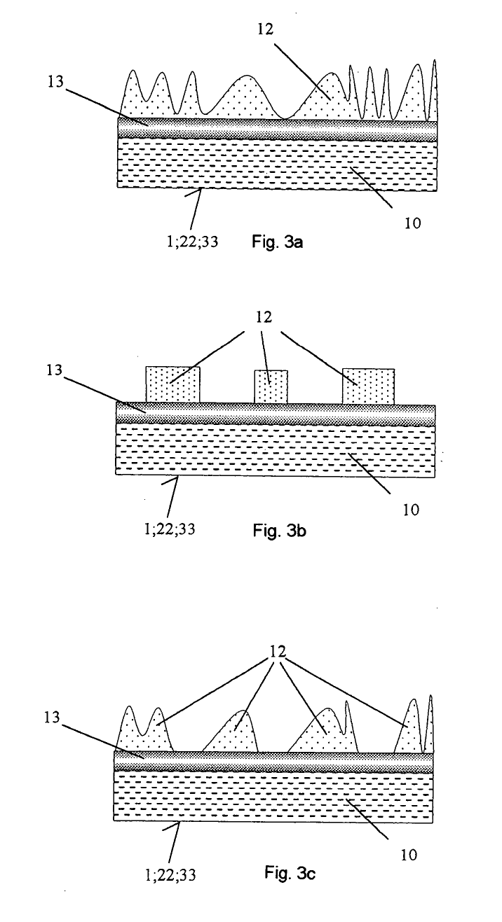

FIGS. 3a-3c depict further variants of a schematic layer structure of connectors;

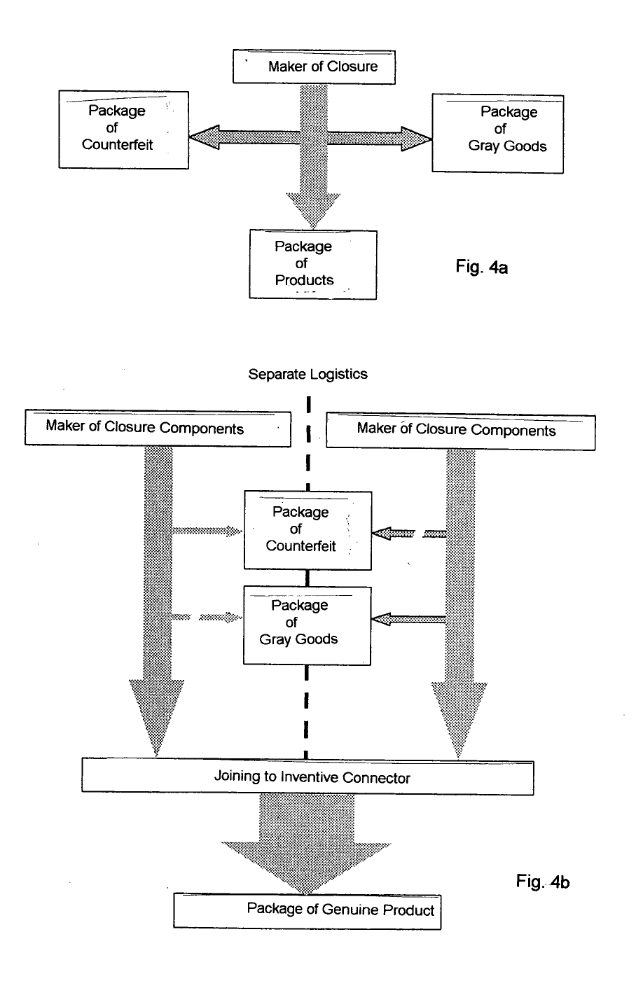

FIGS. 4a-4b depict the flow of goods during the manufacture of connectors and “diversion” during the flow of goods;

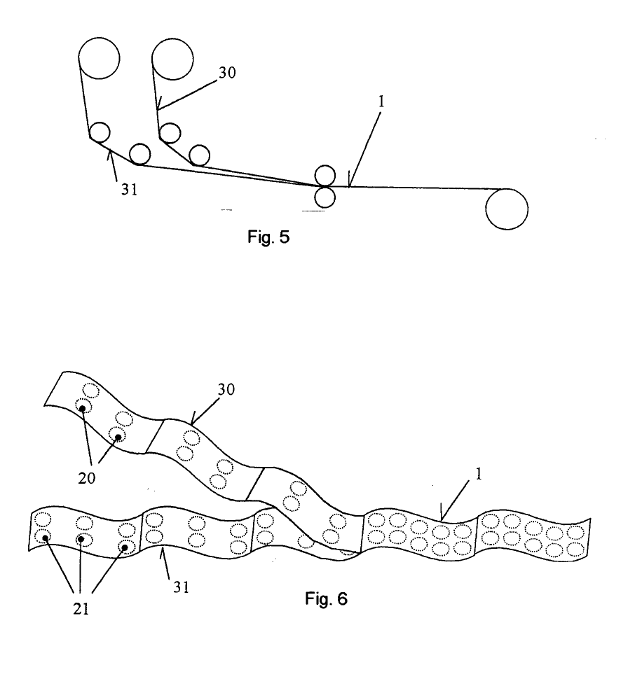

FIG. 5 is a schematic presentation of a two-component connector; and

FIG. 6 is a schematic presentation of an encoded connector made of two components.

### EXAMPLE 1

FIGS. 1a-1c depict various connecting closures 1. FIG. 1, on the basis of a connecting closure 1 of a so-called blister-package 3 for medication, depicts a concrete embodiment of a connector in accordance with the invention as a security feature. The blister-package consists of a molded portion for receiving the medication, and a closure 1. The medication, a pill in particular, may be taken from the blister-package 3 at positions 2 of the closure 1. By its design, the package is identified to a customer as a branded article. Usually the closure 1 of the molded portion is aluminum foil as it may be easily destroyed to remove pills, because encloses the pills in an air-tight manner and protects them from light impingement. Metalized foils require breaking points for easy destruction or an easily destructible foil for removing the pills. FIG. 1b is a partial presentation of a perforated position 5 for opening at one side of a box 4 provided with a tax seal 22. FIG. 1c shows two product components 6; 7 adhesively connected to each other by a label 33. FIG. 1d is a schematic presentation of a partial component of a connector 1, 22, 33 for identifying the genuineness of products 3, 4, 6, 7. It essentially contains a substrate 10, an integral or scattered metalized application or application layer 13 and an electrically conductive polymer 12 having a surface resistance in the order of 15-100 kΩ/□, the difference in the surface resistances of the integral or scattered metalized layer 13 and the surface resistance of the electrically conductive polymer 12 is greater than 100 kΩ/□. The layers may be selectively interchanged. By way of difference to the just described embodiment, the substrate 10 is provided with an integral metalized layer 13 of a surface resistance in excess of 200 kΩ/□. The polymer 12 which is not visible to humans and which in this case is polyethylene dioxythiophene polystyrene sulfonate identifies the manufacturer and the date of manufacture and is shown in FIG. 1e.

### EXAMPLE 2

FIG. 2a depicts a further variant of the connector 1, 22, 33. A substrate 10 is smoothed by a primer 11. The electrically conductive polymer 12, which if necessary is also provided with a primer 11, is provided thereon. This is followed by the metalized layer 13 and, if desired because of the application, a terminal protective layer 14. A primer 11 may also be required between the metalized layer 13 and the protective layer 14. A colored lacquer—not shown in FIG. 2a-may also applied to the protective layer 14 for refining the optical properties. Conceivable, the protective layer 14 itself may consist of such a lacquer layer. The position of the electrically conductive polymer 12 may be exchanged with that of the metallizaed layer 13. The primers 11 used may each act as bonding agents. The connector 1, 22, 33 additionally contains an adhesive layer 15 for connection with products 3, 4, 6, 7. In case the connector 1, 22, 33 is pressure-packed or sealed with a product, there may be no need for the adhesive layer 15. Since the connector 1, 22, 33 is usually coiled on reels it would be sensible to provide one of its surfaces with a release agent 9, especially a silicon film. The release agent 9 of the conncetor 1, 22, 33 may also be a transfer ribbon 16 (FIG. 2c), the transfer ribbon 16 being provided with alignment means 8, e.g. perforations, magnetic tracks or optical markings for precisely positioning the connector 1, 22, 33 relative to products 3, 4, 6, 7. FIG. 2b depicts a further embodiment as an alternative to the version described. The substrate 10 is coated on both surfaces, an electrically conductive polymer 12 being provided on one surface, and the metalized layer 13 being present on the other surface. FIG. 2c shows a further variant. Two partial connectors 30, 31 are manufactured independently of each other and are connected with each other. The partial connectors 30, 31 may, for instance, be connected by adhesive, pressure or sealed, and, when joined, they constitute the connector 1, 22, 33. In addition to other layers, one of the partial connectors 30 consists of a substrate 10 and the electrically conductive polymer 12; and the other partial connector 31 essentially consists of a substrate 10 and the metalized layer 13. Depending upon its intended future use and technological possibilities, the essential layers of the partial connectors 30, 31 may be interchanged, and the partial connector may be joined at different positions.

### EXAMPLE 3

In a further embodiment of the connector 1, 22, 33 or the partial connectors 30, 31 the electrically conductive polymer 12 is applied in a surface-modulating manner. FIG. 3a shows the schematic structure of a partial component of a connector 1, 22, 33. A code results from the changing application thickness and the varying surface resistances resulting therefrom. In the embodiment shown, the modulated surface resistances represent a specific code of the manufacturer (see FIG. 3a).

### EXAMPLE 4

This example describes a connector 1, 22, 33 or partial connectors 30, 31 similar to the one described in connection with Example 6, with the electrically conductive polymer 12 being applied sectionally. As shown in FIG. 3b, the sectional applications of polymer 12 result in sectionally changing surface resistances which again serve as codes and represent production data such as, for instance, logistic routes, charges, places of destination, product classes or serial numbers.

### EXAMPLE 5

As variations of Examples 3 and 4, FIG. 3c depicts a further embodiment of a connector 1, 22, 33 or partial connectors 30, 31. The electrically conductive polymer 12 is applied sectionally, and each section is surface-modulated. The sectionally changing surface resistances result in an code which identifies the manufacturer and the date of manufacture and constitutes a specific code of the manufacturer's.

### EXAMPLE 6

In accordance with this example one or more codes are being proposed combined as in examples 3, 4 and/or 5, the codes being realized in different surface directions. The, the electrically conductive polymer 12 is applied in sectionally surface-modulated in one direction—vide Example 5- and in another direction it is applied sectionally—vide Example 4— thus crating different codes in the two directions.

### EXAMPLE 7

In a further embodiment of the connector 1, 22, 33 or partial connectors 30, 31, a primer 11 is applied sectionally or surface-modulatingly or sectionally surface-modulatingly in the manner of the conductive polymer 12 in examples 3 to 6. The thus resulting structure of the application of the primer 11 is transferred as a master structure on the layer of electrically conductive polymer 12 to be applied and/or on the metalized layer 13. The resulting codes are like those described in Examples 3 to 6.

### EXAMPLE 8

FIG. 4a depicts a common flow of goods of a channel of distribution of connectors 1, 22, 33. An authorized manufacturer of safety features manufactures the connectors 1, 22, 33 and furnishes them to a subsequent processor. There are many possibilities of product pirates or unauthorized producers obtaining these connectors 1, 22, 33. Unfortunately, this is often not understood by a control person. As shown in FIG. 4a, the genuine connector is “diverted” during its transport, for instance, to the subsequent processor. FIG. 4b depicts a separate flow of goods in separate logistics, as applied to the connector 1 consisting of two or more components in accordance with the invention. Two manufacturers of connector components manufacture parts of a connector 1, 22, 33 and furnish them to a subsequent processor. Preferably, these partial connectors 30, 31 will only be applied by a conventional transfer process—shown in FIG. 5 at the subsequent processor and either individually or in combination with each other constitute codes. Advantageously, the partial connectors 30, 31 or the combination of partial connectors 30, 31 should be compatible with conventional systems. The combination yield a substantially higher level of security since the two component reach the user by way of different channels of distribution. As result of the separately furnished components, a very high obstacle is created for forgers or criminals or unauthorized manufacturers and is shown in FIG. 4b by interrupted arrows. As has been explained supra, each partial connector 30, 31 may by itself or as a combination of the partial connectors 30, 31 represent a code. The combination of two partial connectors 30, 31 results in a coded connector 1, 22, 33. The creation of the code is depicted in FIG. 6. The desired code which represents the genuineness of the product is only created by the exact interfitting of the two partial connectors 30, 31. Various code versions may be obtained by a deliberate offset when joining the two partial connectors 30, 31. The individual coding mens may be of different, preferably, electrical, optical, magnetic, functionalities. Their number, arrangement, geometry and properties or any combination thereof, results in codes which can be detected by a control person. In this example, the code in the partial connector 30 represents the place of manufacture 20, and the code in the partial connector 31 represents manufacturing data.

### EXAMPLE 9

In a manner different form example 12, the codes in the individual partial connectors 30, 31 of this preferred embodiment are incomplete and result in a decodable or detectable code only after they have been formed into a complete connector 1, 22, 33. In particular, the individual partial connectors 30, 31 may be provided with encoding means which may be affected physically, for instance, by an application of energy, such as visible light, UV, IR or heat radiation or by chemical action. It is also within the ambit of the invention to provide individual partial connectors 30, 31 with components of a reaction dye which react when brought into contact with each other.

### EXAMPLE 10

By using the variants described in the examples, a code is activated only after joining a connector 1, 22, 33 with a product 3, 4, 6, 7. Combining the connector 1, 22, 33 with markings of the product 3, 4, 6, 7 results in a decodable or detectable code, for instance by precise alignment of the connector 1, 22, 33 relative to the product 3, 4, 6, 7.

The elements of the invention are apparent not only from the embodiments here described, but also from the claims and drawings. The elements individually or as sub-combinations of the individual elements constitute advantageous, protect able embodiments for which protection is hereby claimed.

1. Security features, preferably connectors (1, 22, 33) like labels, tax seals, closures for blister packages and integral markings for connecting seams (8) of products or product packages for identifying the genuineness of products (3, 4, 6, 7), consisting of substrates (10), integral and scattered metalized applications (13) of a defined surface resistance and electrically conductive polymers (12) of a defined surface resistance, the difference between the surface resistances being greater than 100 kΩ/□ and the connectors (1, 22, 33) being connected with products (3, 4, 6, 7).

2. The security feature of claim 1, characterized by the fact that the surface resistance of integral or scattered metalized applications (13) is greater than 200 kΩ/□.

3. The security features of claim 1, characterized by the fact that the surface resistance of electrically conductive polymers is in the range of from 15-100 kΩ/□.

4. The security features of claim 1, characterized by the fact that one or more substrates (10), electrically conductive polymers (12) and integral or scattered metalized applications (13) are arranged for selective interchangeablity.

5. The security features of claim 1, characterized by the fact that the connectors (1, 22, 33) selectively contain protective layers (14), release agents (9) or adhesive layers (15) and that they are arranged for interchangeability.

6. The security features of claim 5, characterized by the fact that the release agent preferably is a siliconized layer or a transfer ribbon (16) and that it is provided with alignment means (8), for instance perforations, magnetic tracks, optical markings or a combination thereof.

7. The security features of claim 1, characterized by the fact that the connectors (1, 22, 33) contain primers (11) smoothing substrates (10) and serving as bonding agents.

8. The security features of one or more of the preceding claims, characterized by the fact that electrically conductive polymers (12), integral or scattered metalized applications (13), substrates (10), protective layers (14) and primers (11) are selective arranged as encoding means.

9. The security features of one or more of the preceding claims, characterized by the fact that the encoding means are provided with electrical and/or optical and/or magnetic functionalities.

10. The security features of one or more of the preceding claims, characterized by the fact that the electrically conductive polymers (12) are applied sectionally or surface-modulatingly or sectionally surface-modulatingly.

11. The security features of one or more of the preceding claims, characterized by the fact that the surface resistance of the electrically conductive polymers (12) constitutes a readable code, particularly detectable by capacitive coupling.

12. The security features of one or more of the preceding claims, characterized by the fact that the integral or scattered metalized applications (13) are applied sectionally, surface-modulatingly or sectionally-surface-modulatingly.

13. The security features of one or more of the preceding claims, characterized by the fact that the surface resistance of the integral or scattered metalized applications constitutes a readable code, particularly detectable by capacitive coupling.

14. The security features of one or more of the preceding claims, characterized by the fact that the encoding means may be affected physically or chemically.

15. The security features of one or more of the preceding claims, characterized by the fact that as security characteristics the encoding means react by application of energy, in particular visible light, UV, IR, or heat radiation in the connectors (1, 22, 33) and/or during joining with the products (3, 4, 6, 7).

16. The security features of one or more of the preceding claims, characterized by the fact that the encoding means consist of components of a reaction dye and that they react only when the components contact each other.

17. The security features of one or more of the preceding claims, characterized by the fact that the primer (11) is applied sectionally of surface-modulatingly.

18. The security features of one or more of the preceding claims, characterized by the fact that the electrically conductive polymer (12) is a polyethylene dioxythiophene polystyrene sulfonate.

19. Security features, preferably connectors (1, 22, 33) such as labels, tax seals, closures for blister packages and integral markings for joining seams (8) of products or product packages for identifying the genuineness of products (3, 4, 6, 7) as described in claims 1 to 18, consisting of a plurality of partial connectors (30, 31) each partial connector (30, 31) consisting of substrates (10), integral or scatted metalized applications (13) of defined surface resistance or of electrically conductive polymers (12) of defined surface resistance or of a combination thereof, the difference between the surface resistances being greater than 100 kΩ/□ and that connectors (1, 22, 33) joined by partial connectors (30, 31) identify products (3, 4) or product components (6, 7) or product packages by a code.

20. The security feature of claim 19, characterized by the fact one or more substrates (10), electrically conductive polymers (12) integral or scattered metalized applications (13), protective layers (14), release agents (9), alignment means (8), primers (11) and adhesive layers (15) are arranged for selective interchangeability and that they are arranged in different numbers in the individual partial connectors (30, 31).

21. The security features of claims 19 and 20, characterized by the fact that in their layer structure the partial connectors (30, 31) are arranged such that they contain their own encoding means and that in a state of being connected to each other the partial connectors (30, 31) contain different compounded encoding means.

22. The security features of one or more of claims 19 to 21, characterized by the fact that components in the partial connectors (30, 31) contain a reaction dye and that the components only react with each other to an encoding means only when the partial connectors (30, 31) contact each other.

23. The security features of one or more of the preceding claims 1 to 22, characterized by the fact that the connector (1, 22, 33) and/or the partial connectors (30, 31) contain encoding means arranged sectionally, or surface-modulatedly or sectionally surface-modulatedly in different surface directions.
